(19) United States
(12) Patent Application Publication
(10) Pub. No.: US 2026/0233986 A1
(43) Pub. Date: Aug. 13, 2026

(54) MODULAR RFID READER FOR FUEL DISPENSING NOZZLE

(71) Applicant: ASSA ABLOY AB, Stockholm (SE)

(72) Inventors: Adrian Boutelje, Westmead (ZA); Scot Cowley, Durban (ZA); Nicholas Holmes, Cardiff (GB)

(21) Appl. No.: 19/156,591

(22) PCT Filed: Feb. 24, 2023
(86) PCT No.: PCT/EP2023/054660

§ 371 Date: Aug. 14, 2025

(51) Int. Cl. B67D 7/14; B67D 7/34; G06K 7/10

(52) U.S. Cl. CPC B67D 7/145; B67D 7/348; G06K 7/10366

(57) ABSTRACT

A battery module, a main module and a modular RFID reader. The battery module is configured to be releasably connected to the main module such that when connected the battery module and the main module together form an RFID reader attachable to a fuel dispensing nozzle. The battery module comprises a first antenna a battery control circuitry a battery cell, a first electrical connector and a battery case The main module comprises a second antenna a main control circuitry a second electrical connector and a main case The modular RFID reader comprises multiple battery modules a main module and a connecting means such as bolts configured to connect one of the multiple battery modules with the main module. Each of the multiple battery modules is individually connectable to the main module to form an RFID reader

### TECHNICAL FIELD

The present disclosure generally relates to the field of fuel management systems and more particularly, it relates to a modular RFID reader of a fuel management system configured to be attached to a fuel dispensing nozzle.

### BACKGROUND

Fuel Management Systems (FMS) are used to control and monitor the distribution of fuel. FMS may for example be used to authorize dedicated vehicles to dispense fuel from dedicated fueling stations and to monitor the costs incurred for such authorized fuel dispensing processes. By means of FMS it is possible to avoid misallocation or theft and to precisely monitor the fuel burn of a vehicle fleet.

FMS are known which comprise RFID readers, RFID tags and a controller. The RFID readers are positioned on a fuel dispensing nozzle. Such RFID readers are able to communicate with a vehicle to be fueled by means of RFID tags of which at least one is positioned on the vehicle. Further, such RFID readers are able to communicate with the controller of the FMS which stores and processes the data provided by the RFID reader in order to control processes such as the fuel dispensing process for the vehicle to be fueled.

RFID readers of FMS may experience much abuse such as dropping, hitting and scraping during service which may have detrimental effects on the RFID reader. Known RFID readers often have integrated batteries and are disposable when the batteries deplete. Usually, RFID readers are customized for a specific application.

The present disclosure is directed, at least in part, to improving or overcoming one or more aspects of prior systems.

### SUMMARY OF THE DISCLOSURE

According to a first aspect, the present disclosure relates to a battery module which is configured to be releasably connected to a main module such that when connected the battery module and the main module together form an RFID reader attachable to a fuel dispensing nozzle. The battery module comprises a first antenna, a battery control circuitry, a battery cell, a first electrical connector and a battery case. The first antenna is configured to send and receive signals to an RFID tag. The battery control circuitry is electrically connected to the first antenna. The battery cell is electrically connected to the battery control circuitry and configured to provide power for operation of the RFID reader. The first electrical connector is connected to the battery control circuitry and is connectable to a second electrical connector on the main module when the battery module is connected to the main module to form the RFID reader. The battery case accommodates (houses) the battery control circuitry, the battery cell and the first electrical connector.

According to a second aspect, the present disclosure relates to a main module which is configured to be releasably connected to the battery module according to the first aspect of the present disclosure such that when connected the main module and the battery module together form the RFID reader attachable to a fuel dispensing nozzle. The main module comprises a second antenna, a main control circuitry, a second electrical connector and a main case. The second antenna is configured to send and receive signals to a controller of the fuel management system. The main control circuitry is electrically connected to the second antenna. The second electrical connector is connected to the main control circuitry and is connectable to the first electrical connector of the battery module when the battery module is connected to the main module to form the RFID reader. The main case accommodates (houses) the second antenna, the main control circuitry and the second electrical connector.

According to a third aspect, the present disclosure relates to a modular RFID reader configured to be attached to a fuel dispensing nozzle. The RFID reader comprises multiple battery modules according to the first aspect of the present disclosure, a main module according to the second aspect of the present disclosure, and a connecting means such as bolts configured to releasably connect one of the multiple battery modules with the main module. Each of the multiple battery modules is individually connectable to the main module to form an RFID reader.

The present disclosure is based at least in part on the realization that by providing a modular RFID reader the range of applications of such modular RFID reader can be broadened in comparison to a non-modular RFID reader. The modular RFID reader according to this disclosure comprises multiple battery modules and a main module. A main module can not only be connected to (or in other words: be mated with) one battery module of the multiple battery modules but can be individually connected to (or mated) with each one of the multiple battery modules. Accordingly, one main module and one of the multiple battery modules respectively form an RFID reader according to this disclosure.

The multiple battery modules may be different such that the RFID reader, which is formed by one of the multiple battery modules and the main module, is adaptable to a specific application. The system of a main module and multiple (different) battery modules is referred to as modular RFID reader. The unit of a main module and one of the multiple (different) battery modules, which is connected to or mated with the main module, is referred to as RFID reader. The different battery modules with which the main module is connectable, may for example differ in the type of antenna (design, orientation) used to communicate with RFID tags positioned on a vehicle. Or the different battery modules may differ in the type of battery (number of battery cells, battery casing) or the type of the battery case (shape, material) or the type of battery control circuitry (configuration of circuits).

One of the multiple battery modules of the modular RFID reader is releasably (or in other words: detachably) connected to the main module to form an RFID reader. Due to the modular design or the exchangeability of the battery module, it is possible to replace only the battery module instead of the entire RFID reader. Such replacement for example may be necessary when the battery is empty or broken or when the battery case is scratched/scuffed but still is operational to refresh the installation.

To releasably connect the battery module with the main module known fastening mechanisms such as bolts with nuts, washers, fastening plates or a snap connection (snap coupling) may be used.

The battery cell is electrically connected to the battery control circuitry and is configured to provide power for operation of the RFID reader comprising a battery module and a main module. As an example, the following battery types/sizes may be used: 17330(2/3 A), 17335, 14330 or 14335, 14250 (1/2 AA), 17250. The company Saft Groupe SAS is given as an example for a manufacturer.

Due to the modular design of the battery module, RFID readers with different configurations may be provided. Four exemplary configurations are given in the following.

According to an exemplary first configuration, the RFID reader comprises a battery module with a first fuel dispensing nozzle through hole and a main module with a second fuel dispensing nozzle through hole. The first fuel dispensing nozzle through hole and the second fuel dispensing through hole have such dimensions that a fuel dispensing nozzle is insertable. When a battery module is connected to a main module to form an RFID reader, the first fuel dispensing nozzle through hole and the second fuel dispensing nozzle through hole are aligned with each other such that they form a (continuous) through hole in the RFID reader, through which a fuel dispensing nozzle may be inserted. Such RFID reader is mounted on a fuel dispensing nozzle by inserting the nozzle into the through holes of the battery module and the main module. Such configuration may for example be used for nozzles used for dispensing of fuel such as gasoline, LPG or CNG. The dimensions of the first fuel dispensing nozzle through hole and of the second fuel dispensing nozzle through hole may be adapted depending of the type of fuel dispensing nozzle, the RFID reader shall be attached to. The first fuel dispensing nozzle through hole and/or the second fuel dispensing nozzle through hole may have a circular cylindrical shape with a diameter in the range of 10 mm to 32 mm, preferably in the range of 21 mm to 31 mm. Such shape best suits the most common existing types of fuel dispensing nozzles worldwide that at least partly have a circular cylindrical shape. The outer diameter of such circular cylindrical shape of existing types of fuel dispensing nozzles may be in the range of 9.5 mm to 31.5 mm.

According to an exemplary second configuration, the RFID reader is designed to support large nozzles. Large nozzles may for example be found in mining sites and aircraft fueling. In this configuration, the RFID reader (battery module and main module) are mounted on the side of the nozzle. In order to support this alternative, the first antenna of the battery module may be changed in reading direction and type. Instead of an air core antenna a ferrite core antenna may be used. In addition, as the spout of the nozzle no longer extends through the assembled unit (RFID reader), there is no need for a first fuel dispensing through hole in the battery module which is provided in the exemplary first configuration. Thus, the space that the hole occupies may be used to support the new antenna position and possibly other circuit elements or other components. This alternative may further comprise an indication LED or an activation button.

According to an exemplary third configuration, the RFID reader is designed for use as handheld device. In that case, the battery module supports the creation of a handheld version of the reader. This may be implemented by introducing a mechanism (attachment means) which allow a user to hold the reader in a convenient way.

According to an exemplary fourth configuration, the RFID reader is designed to be used as a diagnostic tool or desktop device. In such configuration, the battery module may comprise additional functionality to determine the health/status of the main module and diagnose any problems/faults as well as update various parameters/firmware of the main circuit. This version may be powered through a wired means (e.g. USB, PSU) and may contain wired communication means (e.g. USB, TTL).

### Antennas

The battery module comprises a first antenna. The first antenna allows communication with an RFID tag by sending and receiving signals to the RFID tag. The RFID tag may be a passive RFID tag or an active RFID tag. As a first antenna for example an air-core antenna, ferrite core antenna, SMD chip antenna, PCB trace antenna or wire whip antenna may be used.

The first antenna may either reside inside of the battery case or may reside external to the battery case, wherein the battery case then may comprise a connector to which the external antenna is connectable.

The main module comprises a second antenna. The second antenna allows communication with a controller by sending and receiving signals that interact with the controller. As a second antenna for example a PCB trace antenna, SMD chip antenna or wire whip antenna may be used. The second antenna may be an UHF antenna.

The main module may comprise a third antenna such as a 2.4 GHz antenna which supports Bluetooth operation. The third antenna may either be used for configuration through a mobile phone or device. The third antenna may also communicate with the controller.

As a third antenna for example a PCB trace antenna, SMD chip antenna or wire whip antenna may be used. According to an exemplary embodiment, the third antenna may be provided on the battery module instead of the main module.

### Control Circuitries

The battery module comprises a battery control circuitry. The battery control circuitry may comprise a printed circuit board. The battery control circuitry comprises a connection option for the first antenna.

The battery module may comprise further components such as one or more LEDs. In that case, the battery control circuitry may comprise additional connection options for the one or more LEDs.

The battery control circuitry may comprise a module identification circuit configured to determine the battery module type and to provide the main control circuitry with the information about the module type of the battery module

The main module comprises a main control circuitry. The main control circuitry may comprise a printed circuit board. The main control circuitry may provide the intelligence for the RFID reader (battery module and main module). The main control circuitry gets its power from the battery control circuitry. The main control circuitry provides the control circuitry for the second antenna and the first antenna located in the battery module. If the main module comprises a third antenna, the main control circuitry provides the control circuitry for the third antenna as well.

The main module may comprise further components such as one or more LEDs. In that case, the main control circuitry may comprise additional connection options for the one or more LEDs. The main control circuitry also controls the LEDs of the main module and the battery module. The main control circuitry may comprise sensors such as an accelerometer.

### Electrical Connectors

The battery module comprises a first electrical connector which is connected to the battery control circuitry and is connectable to a second electrical connector on the main module when the battery module is connected to the main module to form an RFID reader.

The main module comprises a second electrical connector which is connected to the main control circuitry and is connectable to a first electrical connector of the battery module when the battery module is connected to the main module to form an RFID reader.

The first and second electrical connector thus provide an electrical connection between the battery control circuitry of the battery module and the main control circuitry of the main module when the battery module is connected to the main module to form an RFID reader.

Any known electrical connectors may be used. Usually electrical connectors comprise a male connector and a female connector. The first electrical connector may be either a male or a female connector configured to be mated with the corresponding counterpart of the second connector (female respectively male).

A pin connector mechanism is an example for a system of first and second electrical connectors. A pin connector mechanism may for example comprise pogo pins or spring-loaded pins on one side and mating receptacles on the other side (the mating side).

According to an exemplary embodiment, the pin connector mechanism comprises seven pins. The seven pins are arranged in linear fashion. Six pins thereof carry power and data signals and are spaced equally apart. One final seventh pin thereof is the ground connection and is spatially isolated from the rest as the spacing from that final seventh pin to the closest of the other six pins is twice that of the spacing between the six pins. Either the first electrical connector (being provided on the battery module) or to the second electrical connector (being provided on the main module) may comprise the seven pins. The respective other connector may comprise mating receptacles.

Depending on the required transfer of power and data signals, instead of seven pins also less pins (e.g., 4,5,6) or more pins (e.g., 8,9,10) may be used. Thus, for example five (ten) pins may be arranged in linear fashion. Four (nine) pins thereof carry power and data signals and are spaced equally apart. One final fifth (tenth) pin thereof is the ground connection and is spatially isolated from the rest as the spacing from that final fifth (tenth) pin to the closest of the other four (nine) pins is twice that of the spacing between the four (nine) pins.

According to this disclosure the determination and comparison of spaces between the pins may include a tolerance range of at least 0.1 mm such that, for example, 5 mm and 5.1 mm are considered to be equal and 10.1 mm is considered to be twice of 5 mm.

According to an exemplary embodiment, the space (or the pitch) between the adjacent six pins which carry power and data signals is 2.54 mm +/−0.2 mm (tolerance of 0.2 mm). Accordingly, the space between the final seventh pin to the closest of the other six pins is 5.08 mm +/−0.2 mm (tolerance of 0.2 mm).

In other exemplary embodiments, the pitch between adjacent pins which carry power and data signals may be a multiple of 2.54 mm, with a tolerance of 0.2 mm.

The purpose of this unique spacing between signal connections and ground connections is to comply with the clearance requirements in order to be considered safe for use within explosive atmospheres as set out in the standards for intrinsic safety approval as per IEC60079-11: 2011 (Edition 6).

### Battery Case and Main Case

The battery case at least accommodates the battery control circuitry, the battery cell, the first electrical connector. Depending on the embodiments of the battery case, the first antenna and/or additional components may be accommodated as well. The battery case encapsulates the above mentioned components such that the battery module is considered to be safe for use within a constantly present explosive atmosphere. This is assessed and approved in isolation to the main module according to IEC 60079-0: 2017 (Edition 7), and/or IEC60079-11: 2011 (Edition 6).

The main case at least accommodates the main control circuitry, the second antenna and the second electrical connector. The main case may accommodate additional components. The main case encapsulates the main control circuitry, the second antenna and the second electrical connector such that the battery module is considered to be safe for use within a constantly present explosive atmosphere. This is assessed and approved in isolation to the main module according to IEC 60079-0: 2017 (Edition 7), and/or IEC60079-11: 2011 (Edition 6).

The battery case and the main case are formed and matched with each other such that, when the battery case and the main case are connected with each other, they together form a case which at least encloses the battery control circuitry, the battery cell, the first electrical connector, the main control circuity, the second antenna, the second electrical connector. If the first antenna does not resides external to the battery case, the case formed by the battery case and the main case encloses the first antenna as well. By being enclosed the components housed by the battery module and the main module are protected against external conditions such as for example dropping, hitting, scraping or fluids. Vice versa the environment outside of the enclosure is protected from the components housed by the battery module and the main module. The case (formed of the battery case and the main case) may be sealed and reliably protect the components inside the case from external conditions such as fuel. The modular RFID reader may further comprise a gasket. The gasket is configured to provide a sealed connection between the battery case and the main case.

The device as a whole is considered to be safe for use within a constantly present explosive atmosphere only when the main module is paired with battery modules listed on the approval document, any use of any other means of powering the unit renders the entire device unsafe for its intended purpose. The device conforms to the requirements as set out by the standards and regulations for intrinsic safety as per IEC 60079-0: 2017 (Edition 7), and/or IEC60079-11: 2011 (Edition 6).

The battery case and the main case may for example be injection molded. The material of the battery case and the main case may be glass filled polyamide, ABS or polypropylene.

The battery case may comprise several parts or may be integrally formed. The main case may comprise several parts or may be integral formed.

The battery case and the main case may comprise components for encapsulation (filling material, damping material) of the components housed by the respective case.

Each of the battery case and the main case may comprises at least one hole and/or guide for a bolt. The at least one hole and/or guide for a bolt in the battery case and in the main case provides a possibility to fasten the battery module to the main module by means of bolts.

### Further Exemplary Embodiments

According to an exemplary embodiment, the battery module further comprises a magnetic reed switch. The magnetic reed switch is configured to control the power output on the first electrical connector. The magnetic reed switch is used as an input in the battery control circuitry which activates the power output on the battery module. The reed switch is configured normally open, so that when no magnet is present, no power is output or available on the module's external connections.

According to an exemplary embodiment, the battery module further comprises an activator plate. The activator plate comprises a magnet and is attachable to the battery case such that the magnetic reed switch is activatable by means of the activator plate.

The activator plate may comprises of a piece of plastic and a magnet. When the activator plate is attached to the battery module the magnet is brought in range of the magnetic reed switch and activates the magnetic reed switch.

According to an exemplary embodiment, the battery module comprises a push button configured to control the power output on the first electrical connector.

According to an exemplary embodiment, the main case comprises supercapacitors to stabilize the voltage for more stable performance over temperature. The supercapacitors are used to improve on shortcomings of certain battery technologies (i.e. high power, temperature extremes).

According to an exemplary embodiment, the main case comprises a distance element. To provide a secure attachment of the main module to the fuel dispensing nozzle, such distance element may be used to adjust the diameter of the second fuel dispensing nozzle through hole to the outer diameter of the fuel dispensing nozzle. Such distance element may for example be a compression wedge made of nitrile rubber, which provide the correct type of compression for the system. This distance element (compression wedge) has outer geometries which match with the relevant inner geometries of the main module. For each version of the compression wedge, the outer geometries are identical. For each compression wedge the inner geometries will differ and have different internal diameters. Thus, the main module can be attached to different sizes of nozzles.

The distance element may substantially have the shape of a conical frustum. The conical frustum may comprise an open section which allows to mount the conical frustum to the fuel dispensing nozzle from the side. The conical frustum may comprise protrusions on the outer circumference which serve as guiding elements when matched with the main module. The main module of course comprises corresponding grooves at the second fuel dispensing through hole.

According to an exemplary embodiment, the multiple battery modules of the modular RFID reader are different from each other. The multiple battery modules may for example differ in the form of the battery case or in the type of the first antenna.

Due to the provision of different battery modules and the modular approach that each of the multiple (different) battery modules can individually be connected to the main module, the application range of the modular RFID reader according to this disclosure can be very broad.

According to an exemplary embodiment, the modular RFID reader further comprises a stopper element which is configured to provide a surface against which the distance element abuts when inserted in the RFID reader from the second fuel dispensing nozzle through hole towards the first fuel dispensing nozzle through hole. The stopper element may be formed as insert or as part of the gasket.

According to an exemplary embodiment, the battery case and the main case are configured such that a slot (groove) is formed between the cases in assembled state. The slot is formed such that the stopper element can be arranged and fixed in that slot. Accordingly, the stopper element is sandwiched between the battery case and the main case. Each battery module of a modular RFID reader comprises a battery case which is configured to form that slot with the main module.

In addition to the stopper element, part of the gasket may be arranged in that slot as well. In this embodiment, the battery case and the main case are configured such that a slot is formed between the cases in assembled state and the slot is formed such that the stopper element and part of the gasket can be arranged and fixed in that slot. Accordingly, the stopper element and part of the gasket is sandwiched between the battery case and the main case.

According to an exemplary embodiment, the stopper element is formed as insert of the gasket and the gasket is sandwiched between the battery case and the main case. In this embodiment, the battery case and the main case are configured such that a gap is formed between the cases in assembled state. The stopper element and the gasket can be arranged in that gap and thus be fixed.

According to an exemplary embodiment, the modular RFID reader comprises an attachment means configured to attach the RFID reader formed by the battery module and the main module from the side to the fuel dispensing nozzle. Such attachment means may for example comprise one or more loops which may can be placed around the fuel dispensing nozzle and strapped to provide a tight attachment.

Other features and aspects of this disclosure will be apparent from the following description and the accompanying drawings.

### BRIEF DESCRIPTION OF THE DRAWINGS

FIG. 1 schematically illustrates the structure of a known RFID reader in a simplified manner.

FIG. 2 schematically illustrates the structure of an RFID reader according to an exemplary embodiment of the present disclosure in a simplified manner.

FIG. 3 illustrates the different modules of a modular RFID reader according to an exemplary embodiment of the present disclosure

FIG. 4 schematically illustrates an RFID reader according to an exemplary embodiment of the present disclosure which is attached to a fuel dispensing nozzle by insertion of the fuel dispensing nozzle into a through hole of the RFID reader.

FIG. 5 illustrates an example for a distance element.

FIG. 6 is a cross sectional view along line A-A in FIG. 5

FIG. 7 schematically illustrates an RFID reader according to an exemplary embodiment of the present disclosure which is attached to a fuel dispensing nozzle by side mounting of the RFID reader to a fuel dispensing nozzle.

FIG. 8 illustrates an RFID reader according to an exemplary embodiment of the present disclosure which is configured to be used as handheld device.

FIG. 9 illustrates an RFID reader according to an exemplary embodiment of the present disclosure in oblique rear view.

FIG. 10 illustrates an RFID reader according to an exemplary embodiment of the present disclosure in oblique front view.

FIG. 11 is a sectional view of the RFID reader along line B-B in FIG. 10.

FIG. 12 is an exploded view of an RFID reader according to an exemplary embodiment of the present disclosure.

FIG. 13 illustrates a battery module according to an exemplary embodiment of the present disclosure in oblique rear view.

FIG. 14 illustrates a main module according to an exemplary embodiment of the present disclosure in oblique front view.

FIG. 15 shows a fuel dispensing nozzle on which an RFID reader according to an exemplary embodiment of the present disclosure is attached.

### DETAILED DESCRIPTION

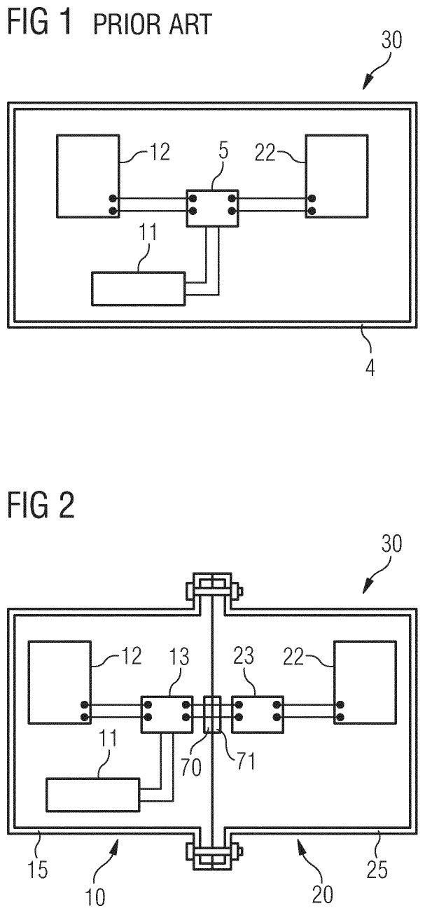

FIG. 1 schematically illustrates the structure of a known RFID reader in a simplified manner. The known RFID reader 30 comprises a case 4. The case houses a first antenna 12 configured to communicate with an RFID tag, a second antenna 22 configured to communicate with a controller of the fuel management system, a control circuitry 5 and a battery cell 11. The control circuitry 5 comprises the electric circuits that controls the operation of the RFID reader 30.

FIG. 2 schematically illustrates the structure of an RFID reader according to an exemplary embodiment of the present disclosure in a simplified manner. The RFID reader 30 has a modular structure. The RFID reader 30 comprises a battery module 10 with the battery case 15 and the main module 20 with the main case 25. The battery case 15 and the main case 25 together form the case of the RFID module 30. The battery case 15 accommodates (houses) a first antenna 12 configured to communicate with an RFID tag, a battery control circuitry 13 and a battery cell 11. The main case 25 houses a second antenna 22 configured to communicate with a controller of the fuel management system and a main control circuitry 23. The battery control circuitry 13 and the main control circuitry 23 are electrically connected when mated by means of a first and second electrical connector 70, 71. The combination of the battery control circuitry and the main control circuitry form a complete working circuitry for an RFID reader.

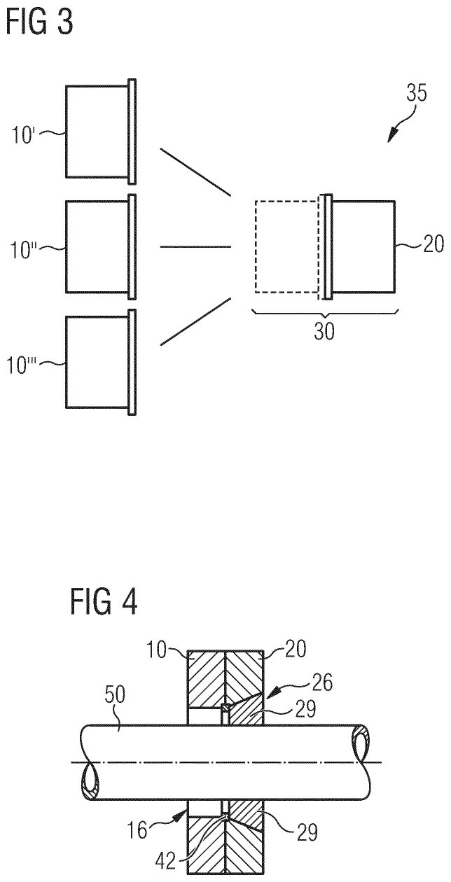

FIG. 3 illustrates the different modules of a modular RFID reader according to an exemplary embodiment of the present disclosure. The modular RFID reader 35 as shown in FIG. 3 comprises three battery modules 10′, 10″, 10″. The three battery modules 10′, 10″, 10′″ are different from each other.

Further, the modular RFID reader 35 comprises a main module 20. Each of the three battery modules 10′, 10″, 10′″ can be connected to the main module 20. If one of the three battery modules 10′, 10″, 10′″ is connected to the main module 20, these two modules form an RFID reader 30. As the battery modules 10′, 10″, 10′″ are different from each other, the three RFID reader 30 which can be formed by the main module 20 and one of the three battery modules 10′, 10″, 10′″ are different from each other too.

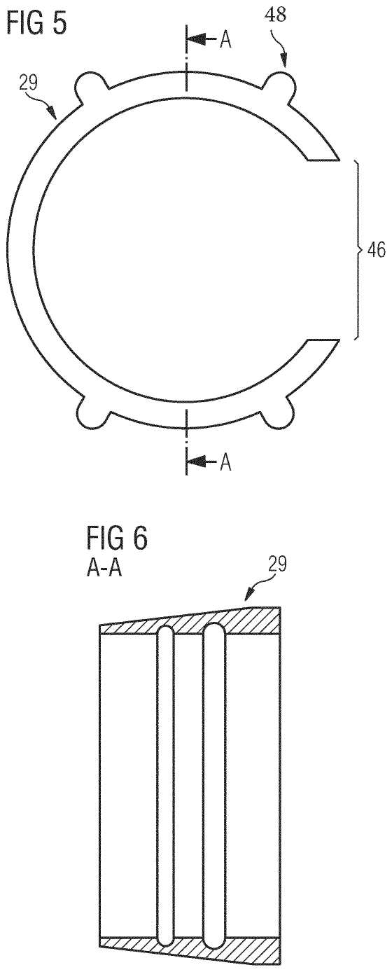

FIG. 4 schematically illustrates an RFID reader 30 according to an exemplary embodiment of the present disclosure which is attached to a fuel dispensing nozzle 50 by insertion of a fuel dispensing nozzle 50 into a through hole of the RFID reader 30. The RFID reader 30 comprises a battery module 10 and a main module 20. The RFID reader 30 has a first fuel dispensing nozzle through hole 16 and a second fuel dispensing nozzle through hole 26. The first fuel dispensing nozzle through hole 16 and the second fuel dispensing nozzle through hole 26 are larger than outer diameter of the fuel dispensing nozzle 50.

The RFID reader 30 is attached to the fuel dispensing nozzle 50 via a distance element 29 which is arranged between the main module 20 and the fuel dispensing nozzle 50.

FIG. 5 illustrates an example for a distance element 29. In front view, the distance element 29, also referred to as compression wedge, has a circular shape which an open section 46. At the outer perimeter of the distance element 29 guiding protrusion 48 are provided which serve as a guiding means when inserting the distance element 29 into the main case of the main module which comprises corresponding grooves.

FIG. 6 is a cross sectional view along line A-A in FIG. 5. The cross-section of the distance element has a wedge like form.

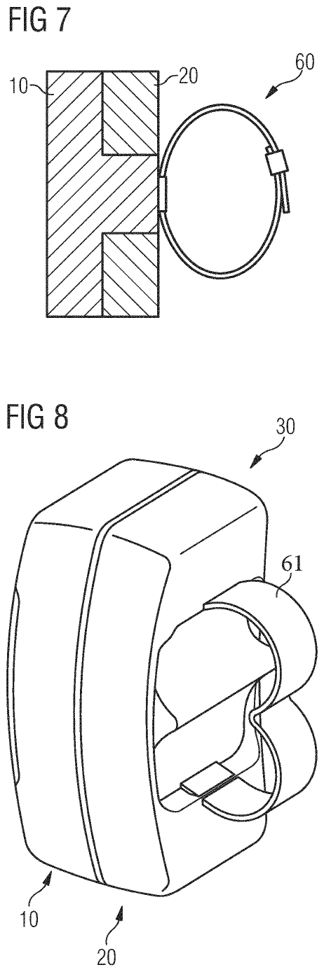

FIG. 7 schematically illustrates an RFID reader according to an exemplary embodiment of the present disclosure which is attachable to a fuel dispensing nozzle by side mounting of the RFID reader to the fuel dispensing nozzle. The RFID reader 30 comprises the battery module 10 and the main module 20. The battery case protrudes in a through hole of the main case. The protrusion of the battery case and the through hole in the main case are matched such that the battery case can be attached to the main case by insertion into the main case which simplifies the assembly of the RFID reader. The RFID reader further comprises an attachment means 60 which is configured to attach the RFID reader to a fuel dispensing nozzle 50. The attachment means 60 is attached to the RFID reader by means of adhesive or bolts or the like (not shown). The attachment means 60 comprises two ties wherein the end of one of the ties is connectable with the end of the other tie. The two ties form a loop. By amending the portion of overlapping of the two ties, the size of the loop may be amended. The loop may comprise soft material on the inside to ensure a form-fit connection with the fuel dispensing nozzle 50. Of course, the attachment means may comprise more than one pair of ties configured to attach the RFID reader to the fuel dispensing nozzle. Other known attachment means may be used to attach the RFID reader to the fuel dispensing nozzle.

FIG. 8 illustrates an RFID reader according to an exemplary embodiment of the present disclosure which is configured to be used as handheld device. The RFID reader 30 comprises the battery module 10 and the main module 20. The RFID reader further comprises an attachment means 61. The attachment means is formed to allow the user to hold the RFID reader in a convention way. The attachment means 61 together with the main module forms two circular shaped portions and is configured such that the user can insert his middle finger and his index finger in the circular shaped portions. The attachment means 61 may be attached to the main case 20 by means of adhesive or bolts or the like (not shown). The attachment means may comprise soft material on the inside to ensure a comfortable use for the use.

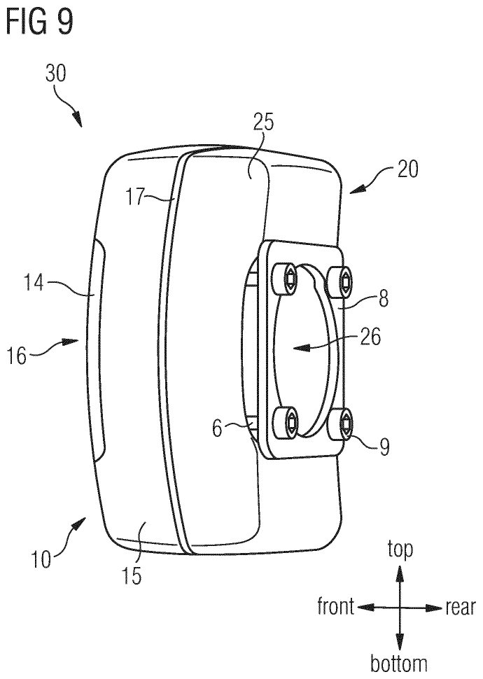

FIG. 9 illustrates an RFID reader 30 according to an exemplary embodiment of the present disclosure in oblique rear view. The RFID reader 30 comprises a battery module 10 and a main module 20. The battery module 10 comprises the battery case 15. The main module 20 comprises the main case 25. The battery case 15 is releasably connected to the main case 25 by means of bolts 6 each of which pass through respective holes/guides in the battery case 15 and in the main case 25 and are fastened with a nut 9. Between the nut 9 and the main case 25 a fastening plate 8 is positioned. Between the battery housing 15 and the main housing 25 a gasket 17 is positioned to provide a sealed connection between the battery case 15 and the main case 25. The RFID reader 30 comprises a first fuel dispensing nozzle through hole 16 (not visible) in the battery case 15 and a second fuel dispensing nozzle through hole 26 in the main case 25. The first fuel dispensing nozzle through hole 16 and the second fuel dispensing nozzle through hole 26 together form a (continuous) through hole in the RFID reader 30 through which a fuel dispensing nozzle is insertable. A activator plate 14 is attached to the battery case 15.

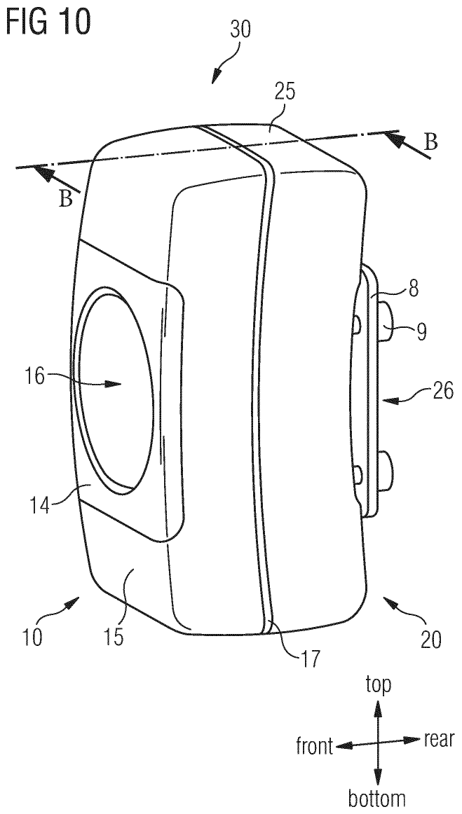

FIG. 10 illustrates an RFID reader 30 according to an exemplary embodiment of the present disclosure in oblique front view. The RFID reader 30 comprises a battery module 10 with a battery housing 15 and a main module 20 with a main housing 25. Between the battery housing 15 and the main housing 25 a gasket 17 is positioned to provide a sealed connection between the battery case 15 and the main case 25. Bolts which pass through respective holes/guides in the battery case 15 and in the main case 25 fasten the battery case 15 to the main case 25. A fastening plate 8 is positioned between the nut 9 of each bolt and the main case 25. The head of each bolt is not visible in FIG. 2 as an activator plate 14 is positioned on top of them. The activator plate 14 comprises a through hole in which a fuel dispensing nozzle is insertable. The RFID reader 30 comprises a first fuel dispensing nozzle through hole 16 in the battery case 15 and a second fuel dispensing nozzle through hole 26 (not visible) in the main case 25. The through hole of the activator plate 14, the first fuel dispensing nozzle through hole 16 and the second fuel dispensing nozzle 26 are aligned such that they together form a (continuous) through hole in the RFID reader 30 through which a fuel dispensing nozzle is insertable.

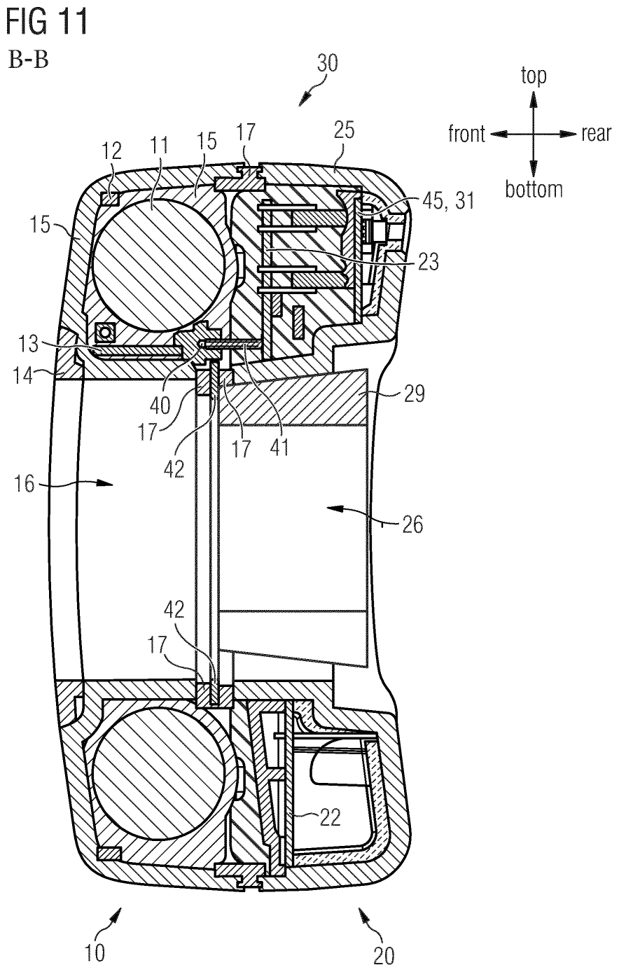

FIG. 11 is a sectional view of the RFID reader 30 along line B-B in FIG. 7. The fastening plate 8, the bolts and nuts 9 are not shown in FIG. 11. The RFID reader 30 comprises a battery module 10 with the battery case 15 and a main module 20 with the main case 25. The battery case 15 is connected to a main case 25. Between the battery case 15 and the main case 25 a gasket 17 is arranged. The battery case 15 comprises multiple parts, one of which provides a supporting structure for the battery cell 11. The battery case 15 further houses a first antenna 12 and a battery control circuitry 13. The battery control circuitry 13 is electrically connected to a main control circuitry 23 of the main module 20 by means of a pin mechanism comprising pins 41 and pin receptacles 41.

In the battery case 15 a first fuel dispensing nozzle through hole 16 is provided. In the main case 25 a second fuel dispensing nozzle through hole 26 is provided. An activator plate 14 is attached to the battery case 15. The activator plate 14 also comprises a through hole. The first fuel dispensing nozzle through hole 16, the second fuel dispensing nozzle through hole 26 and the through hole of the activator plate 14 are arranged side by side to form a through hole which allows a fuel dispensing nozzle to pass through the RFID reader 30.

The main case 25 comprises the main control circuitry 23, a second antenna 22, a third antenna 31 and a LED PCB 45. The second antenna 22 is a separate PCB containing an UHF antenna which communicates with the controller, the third antenna 31 is placed on the same PCB as the LED PCB 45. The third antenna 31 is a Bluetooth antenna.

In the second through dispensing through hole 26 a distance element 29 is inserted. The distance element 29 has a wedge like cross-sectional section. The outer side of the distance element 29 is in contact with the inner side of the main module. As the distance element has an open section on the lower side such that in FIG. 11, the distance element is not in contact with the main module on the lower side. The distance element abuts against a stopper element 42 on its left side. The stopper element 42 is formed as an insert of the gasket 17. The battery case and the main case are matched with each other such that the stopper element 42 and part of the gasket 17 are sandwiched between the main case 25 and the battery case 15. Due to this sandwich structure, the stopper element 42 is fixed in its position.

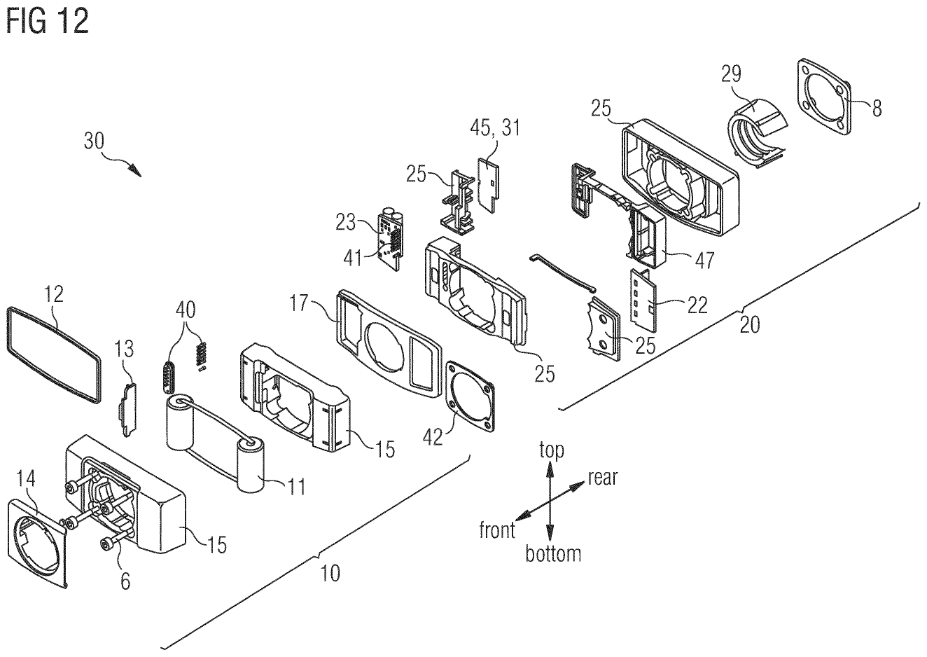

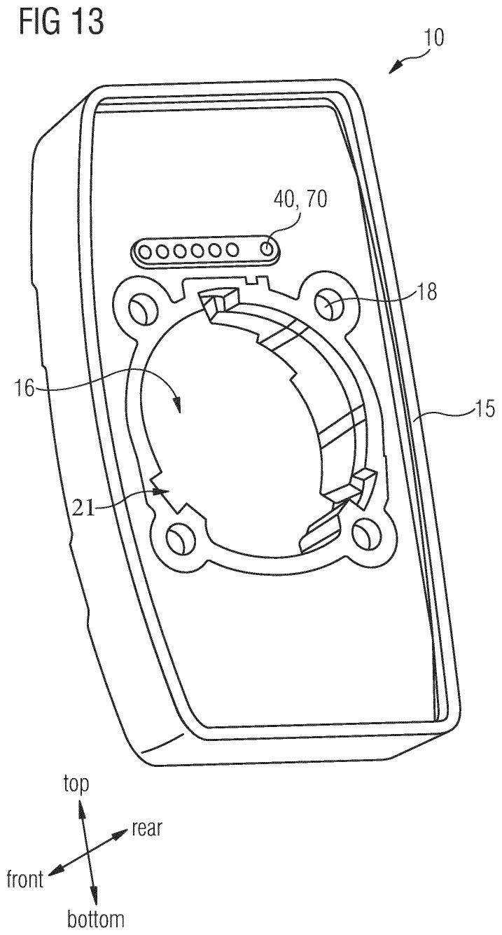

FIG. 12 is an exploded view of the RFID reader 30 according to an exemplary embodiment. On the left side of FIG. 9 to the middle, the components of the battery module 10 of the RFID reader 30 are illustrated. From the middle to the right side of FIG. 4, the components of the main module 20 of the RFID reader 30 are illustrated.

The battery module 10 comprises the battery case 15. The battery case 15 comprises holes through which bolts 6 are insertable. An activator plate 14 is attachable to the battery case 15 such that the holes for the bolts 6 are covered. The battery case 15 comprises two parts. The battery case 15 houses a battery cell 11 as well as a first antenna 12 and a battery control circuitry 13. A gasket 17 is positioned on the right hand side of the battery case 15 and forms a contact surface for the main case 25 of the main module 20 which is connected to the battery module 10. Further, a stopper element 42 is arranged between the battery case 15 and the main case 25.

The main module 20 comprises the main case 25. The main case 25 is formed of several parts which are insertable in each other and provide a support structure for the main control circuitry 23, the second antenna 22 and the third antenna 31. The third antenna 31 is placed on the same PCB as the LED PCB 45. The main control circuitry 23 and the battery control circuitry are electrically connectable by means of a pin mechanism 40, 41.

On the far right a fastening plate 8 is illustrated. By means of the bolts 6 (each of which pass through respective holes/guides in the battery case 15 and in the main case 25) and the fastening plate 8 the battery module 10 is pressed on the main module 20.

The main module further comprises a distance element 29. The distance element 29 is used to attach the main module 20 (the main case 25) to the fueling dispensing nozzle.

The main case 25 further houses LED PCB 45. The LED PCB 45 comprises the third antenna 31, and the LED's are visible through a light pipe 47 in main case 25. The light pipe 47 is used to view the LEDs and is molded directly into the main case 25.

FIG. 13 illustrates a battery module 10 according to an exemplary embodiment of the present disclosure in oblique rear view. The battery module 10 comprises the battery case 15. The battery case 15 provides a support structure for the battery cell 11 (not visible as covered by the battery case 15). The battery module comprises a first electrical connector 70 which is formed as seven pin receptacles 40. The seven pin receptacles 40 are arranged in linear fashion. Six pin receptacles are spaced equally apart from each other. The seventh pin receptacle is spatially isolated from the other receptacles as the spacing from that seventh pin receptacle to the closest of the other six pin receptacles is twice that of the spacing between the six pin receptacles. The battery case 15 comprises four holes for a bolt 18 which are arranged around the first fuel dispensing nozzle through hole 16.

The first dispensing nozzle through hole 16 comprises grooves 21 on the circumference. These grooves are guiding means for the activator plate which of course has complementary counterparts.

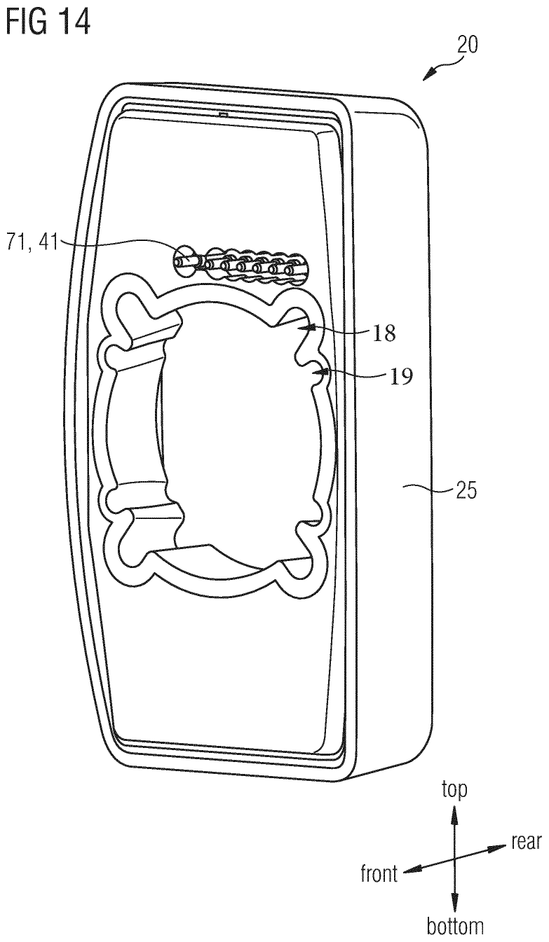

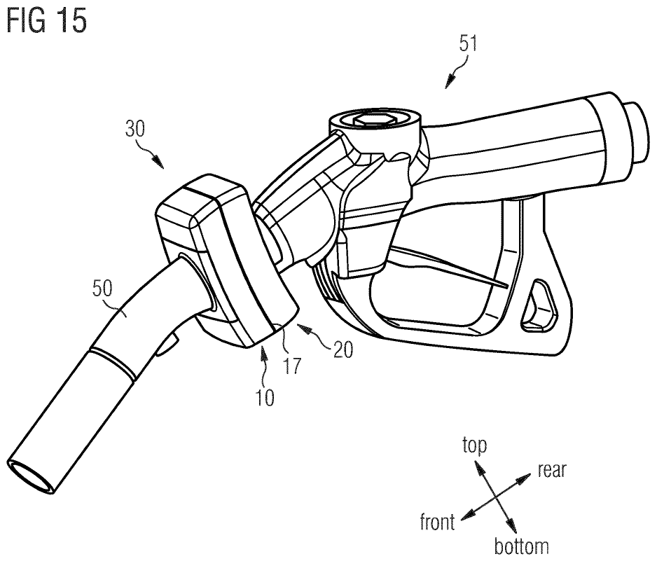

FIG. 14 illustrates a main module 20 according to an exemplary embodiment of the present disclosure in oblique front view. The main module 20 comprises the main case 25. The main module comprises a second electrical connector 71 which is formed as seven pins protruding from the main case 25 towards the front side (where the battery module 10 is arranged in assembled state of the modular RFID reader). The contact pins are configured to be mated with pin receptacles on the battery module. The seven pins 41 are arranged in linear fashion. Six pins are spaced equally apart from each other. The seventh pin is spatially isolated from the other pins as the spacing from that seventh pin to the closest of the other six pins is twice that of the spacing between the six pins.

The through hole comprises grooves 18, 19 on the circumference. The grooves 19 are guiding means for the distance element 29 which of course has complementary counterparts. The grooves 18 are guides for the bolts which are used to attach the battery case to the main case.

FIG. 15 shows a fuel dispensing nozzle 50 of a fuel dispensing gun 51 on which an RFID reader 30 is attached. The RFID reader 30 comprises the battery module 10 and the main module 20. The RFID reader 30 is attached to the fuel dispensing nozzle 50 such that the battery module 10 is positioned closer to the outlet for fuel of the fuel dispensing nozzle 50 compared to the main module 20. The RFID reader 30 is attached to the fuel dispensing nozzle 50 by inserting the fuel dispensing nozzle 50 in a through hole of the RFID reader.

### INDUSTRIAL APPLICABILITY

Due to the modularity of the modular RFID reader according to this disclosure, the application range of the modular RFID reader can be very broad. The provision of different battery modules and the approach that each of the multiple (different) battery modules can individually be connected to one single main module, the RFID reader is easily adjustable to a specific application.

Due to the modular design of the modular RFID reader and the exchangeability of the battery module, it is further possible to replace only the battery module instead of the entire RFID reader when the battery module malfunctions or the battery cell is empty.

With reference to FIG. 3 and FIG. 15 the use of the modular RFID reader is explained. As shown in FIG. 3, a modular RFID reader may for example comprise three different battery modules 10′, 10″, 10′″. Further, the modular RFID reader 35 comprises a single main module 20. Depending of the specific application, the user can connect each of the three battery modules 10′, 10″, 10′″ individually to the main module 20. One battery modules 10′, 10″, 10′″ and the main module 20 form an RFID reader 30. As the battery modules 10′, 10″, 10′″ are different from each other, the three RFID readers 30 which can be formed by the main module 20 and one of the three battery modules 10′, 10″, 10′″ are different from each other too. Thus, the RFID reader may be adapted to the specific application.

As shown in FIG. 15, the RFID reader 30 may be attached to a fuel dispensing nozzle 50 by inserting the fuel dispensing nozzle 50 into a through hole of the RFID reader 30. There are different options to attach the modular RFID reader 30 to the fuel dispensing nozzle 50.

For example, it is possible to firstly move the main module 20 over the fuel dispensing nozzle 50. By means of distance elements 29, the main module 20 may be fixed to the fuel dispensing nozzle 50 at a determined position. Then, the battery module 10 may be moved over the fuel dispensing nozzle 50. such that it is positioned next to the main module 20. Then, the battery module 10 and the main module 20 are connected to each other by for example bolts. Before the battery module 10 is moved over the fuel dispensing nozzle 50, a gasket 17 may be positioned on the battery module 10 or the main module 20 to provide a sealed connection between the battery module 10 and the main module 20. The battery module 10 is releasably connected to the main module 20 such that it may be replaced by another battery module 10 while the main module 20 remains attached to the fuel dispensing nozzle 50. The another battery module 10′ may be different from the replaced battery module 10″

Alternatively, the RFID module 30 may be firstly amended by connecting the battery module 10 to the main module 20 and then (as a unit) moved over the fuel dispensing nozzle 50.

Terms such as “about”, “around”, “approximately”, or “substantially” as used herein when referring to a measurable value such as a parameter, an amount, a temporal duration, and the like, is meant to encompass variations of ±10% or less, preferably ±5% or less, more preferably ±1% or less, and still more preferably ±0.1% or less of and from the specified value, insofar as such variations are appropriate to perform in the disclosed invention. It is to be understood that the value to which the modifier “about” refers is itself also specifically, and preferably, disclosed. The recitation of numerical ranges by endpoints includes all numbers and fractions subsumed within the respective ranges, as well as the recited endpoints.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

### LIST OF ELEMENTS

4 case
5 control circuitry
6 bolt
600
8 fastening plate
9 nut
10, 10′, 10″, 10′″ battery module
11 battery cell
12 first antenna
13 battery control circuitry
14 activator plate
15 battery case
16 first fuel dispensing nozzle through hole
17 gasket
18 hole/guide for a bolt
19 guiding groove for distance element
20 main module
21 guiding groove for activator plate
22 second antenna
23 main control circuitry
25 main case
26 second fuel dispensing nozzle through hole
29 distance element (compression wedge)
30 RFID reader
31 third antenna
35 modular RFID reader
40 pin receptacle
41 pin
42 stopper element
45 LED PCB
46 distance element open section
47 light pipe
48 guiding protrusion on distance element
50 fuel dispensing nozzle
51 fuel dispenser gun
60 attachment means for side mount
61 attachment means for handheld use
70 first electrical connector
71 second electrical connector

1. A battery module configured to be releasably connected to a main module such that when connected the battery module and the main module together form an RFID reader attachable to a fuel dispensing nozzle the battery module comprising:
a first antenna configured to send and receive signals to an RFID tag;
a battery control circuitry electrically connected to the first antenna;
a battery cell electrically connected to the battery control circuitry and configured to provide power for operation of the RFID reader;
a first electrical connector which is connected to the battery control circuitry and is connectable to a second electrical connector on the main module when the battery module is connected to the main module to form the RFID reader; and
a battery case accommodating the battery control circuitry the battery cell and the first electrical connector

2. The battery module according to claim 1, wherein the first antenna resides inside of the battery case

3. The battery module according to claim 1, wherein the first antenna resides external to the battery case

4. The battery module according to claim 1, wherein the first electrical connector and the second electrical connector form a pin connection comprising a pin and a pin receptacle and the first electrical connector either comprises the pin or the pin receptacle

5. The battery module according to claim 1, further comprising a magnetic reed switch being configured to energize the battery control circuitry and the first electrical connector.

6. The battery module according to claim 5, further comprising an activator plate comprising a magnet and being attachable to the battery case such that the magnetic reed switch is activatable by means of the activator plate.

7. The battery module according to claim 1, further comprising a push button configured to energize the battery control circuitry and the first electrical connector.

8. The battery module according to claim 1, wherein the battery case comprises a fuel dispensing nozzle through hole, the fuel dispensing nozzle through hole having such dimensions that the fuel dispensing nozzle is insertable therethrough.

9. The battery module according to claim 8, wherein the fuel dispensing nozzle through hole has a circular cylindrical shape with a diameter in the range of 10 mm to 32 mm.

10. A main module configured to be releasably connected to the battery module according to claim 1 such that when connected the main module and the battery module together form an RFID reader attachable to the fuel dispensing nozzle the main module comprising:
a second antenna configured to send and receive signals to a controller of the a fuel management system;
a main control circuitry electrically connected to the second antenna;
the second electrical connector which is connected to the main control circuitry and is connectable to the first electrical connector of the battery module when the battery module is connected to the main module to form the RFID reader; and
a main case accommodating the second antenna, the main control circuitry and the second electrical connector.

11. The main module according to claim 10, wherein the first electrical connector and the second electrical connector form a pin connection comprising a pin and a pin receptacle and the second electrical connector either comprises the pin or the pin receptacle.

12. The main module according to claim 11, wherein the second electrical connector comprises seven pins arranged in linear fashion, of which:
six pins carry power and data signals and are spaced equally apart from each other; and
a seventh pin is a ground connection and is spatially isolated from the six pins so that spacing from that seventh pin to a closest of the other six pins is twice that of a spacing between the six pins.

13. The main module according to claim 10, further comprising a third antenna antenna, the third antenna supporting Bluetooth operation.

14. (canceled)

15. The main module according to claim 10, wherein the main case comprises a fuel dispensing nozzle through hole, the fuel dispensing nozzle through hole having such dimensions that the fuel dispensing nozzle is insertable therethrough.

16. The main module according to claim 15, wherein the fuel dispensing nozzle through hole has a circular cylindrical shape with a diameter in the range of 10 mm to 32 mm.

17. The main module according to claim 10, further comprising a distance element wedge configured to be positioned between the main module and the fuel dispensing nozzle to provide a secure connection between these components.

18. A modular RFID reader of a fuel management system configured to be attached to a fuel dispensing nozzle, the modular RFID reader comprising:
multiple battery modules;
a main module; and
a connecting means configured to releasably connect one of the multiple battery modules with the main module;
wherein each battery module comprises:
a first antenna configured to send and receive signals to an RFID tag:
a battery control circuitry electrically connected to the first antenna;
a battery cell electrically connected to the battery control circuitry;
a first electrical connector which is connected to the battery control circuitry and is connectable to a second electrical connector on the main module when the battery module is connected to the main module; and
a battery case accommodating the battery control circuitry, the battery cell and the first electrical connector;
wherein the main module comprises:
a second antenna configured to send and receive signals to a controller of the fuel management system;
a main control circuitry electrically connected to the second antenna;
the second electrical connector, which is connected to the main control circuitry; and
a main case accommodating the second antenna, the main control circuitry and the second electrical connector; and
wherein each of the multiple battery modules is individually connectable to the main module to form an RFID reader

19. (canceled)

20. The modular RFID reader according to claim 18, further comprising a gasket configured to seal a connection between the one of the multiple battery modules and the main module.

21-23. (canceled)

24. The modular RFID reader according to claim 18, wherein the multiple battery modules are different from each other in at least one of shape of the battery case, type of first antenna, type of the battery cell or the functionality of the battery control circuitry.

25. (canceled)

26. The main module according to claim 11, wherein seven pins are provided on the first electrical connector and the second electrical connector comprises seven pin receptacles that are formed and arranged complementary to the seven pins on the first electrical connector.
